(19) United States
(12) Patent Application Publication
(10) Pub. No.: US 2005/0103065 A1
(43) Pub. Date: May 19, 2005

(54) Protective cover for locking devices

(76) Inventor: Gordon K. Dennis, Lansdale, PA (US)

Correspondence Address: RATNERPRESTIA, P.O. BOX 1596, WILMINGTON, DE, 19899, US

(21) Appl. No.: 10/716,586

(22) Filed: Nov. 19, 2003

(51) Int. Cl. E05B 67/38

(52) U.S. Cl. 70/56

(57) ABSTRACT

A locking device protective cover system and method of installing such a protective cover system are disclosed. The inventive protective cover system includes a solid shroud or cover, anchor elements to attach the shroud in place over the locking device, a hasp element extending at least partially under the protective cover and to which the locking device is locked, such that upon locking the locking device to the hasp element, the locking device can not be removed from the hasp element unless the locking device is unlocked. As installed, the protective cover shields the locking device from vandalism. The inventive system is flexible such that it may be applied to most any access door and access way that can be secured by using an internally mounted hasp element sized and configured to engage with a locking device under the protective shroud.

This invention generally relates to security covers for locking devices. More particularly, the present invention is directed to an inventive apparatus that provides a protective cover or shroud for a padlock or padlock type device. The apparatus elements include, in a basic embodiment, a protective cover or shroud sized to cover part or all of a locking device, and a hasp element to which the locking device is locked. The hasp element is the rigid part to which the locking device is attached. In another preferred embodiment, a series of anchors may be attached to the protective cover to further secure the attachment of the cover in place. As such, when installed, the protective cover shields the locking device that is lockably engaged to the hasp element. The protective shield is designed to provide an additional level of security against certain vandalism of locking devices. The apparatus is design to be easily installed as part of in-place access doors and access ways and thereby provide further security and protection from unauthorized entry to access ways and access areas.

### BACKGROUND DESCRIPTION

It is an acknowledged fact today that property owners need to be cognizant of security issues. That is, property owners must provide additional levels of security to their property and to facilities or access areas maintained on their property. While this is especially the case where the property owners are utility organizations, including water, gas, or electric companies, it is equally true for other property owners that have access areas housing local utility subsystems, such as apartment complexes.

Access doors, through which entry to access areas is provided, use various types of locking devices to prevent unauthorized entry. Such locking devices include simple channel keyed handles, dead bolts, or finding more prevalence today, separate locking devices, including padlocks. The advantage of a separate padlock is that it often is not possible to force open the lock, such as may be possible with a simple channel keyed handle. However, padlocks have a disadvantage of being relatively readily vandalized or destroyed with, for example, bolt cutters. To protect or secure the locking device, a cover may be used. The security cover must be able to be easily installed and yet not restrict use of the locking device.

Covers to protect locking devices have been designed and patented, however, none appear to have universal application to locking devices used on various types of access doors. An example is disclosed in U.S. Pat. No. 6,581,419 issued to Strodtman, for a “Hasp And Lock Cover For Cargo Doors.” The Strodtman invention provides a teaching of a hasp and lock cover for installation on a camming handle of a cargo door of cargo carrying vehicles and shipping containers. The Strodtman cover is a unitary rigid box-like device having a contiguous front wall, laterally opposed side walls, a top end wall, an open back side, and an open bottom end defining an interior. While the Strodtman cover provides certain protection to a locking device, such as a padlock, it is not affixed to any access door, but is a loose component that is susceptible to being lost, damaged, or not even used.

Similarly, U.S. Pat. No. 6,578,393 issued to Yarborought for a “Security Cover For Padlock” discloses a security cover that is a box-shaped housing installed on a hasp, with the housing having a first, second and third opening. The Yarborought security cover does provide a certain level of protection to the locking device or padlock, however, given the installation of the cover on the hasp, instead of to the access door, the protection is very limited. Indeed, the hasp, as shown in the Yarborought disclosure, is very vulnerable to vandalism thereby rendering any protection provided to the locking device a moot issue.

Finally, U.S. Pat. No. 6,463,769 issued to Garner for a “Lock Box Apparatus For A Padlock” teaches a housing apparatus to protect a padlock, where the housing is securable to a door and having an aperture on the back of the housing to receive a fixed hasp plate that is secured to a second door or secured to a door frame. As illustrated and described in Garner, it appears the lock box is limited to usage with a “Buffalo” type of padlock. Consideration of the drawings provided in Garner shows that the disclosed lock box will not allow usage of traditional padlock with pivoting shackles. Moreover, the Garner lock box is attached to an access door such that at least a substantial section of the box extends in cantilever fashion beyond the edge of the door. This presents an increased safety hazard as the access door is swung open or closed and operators are not expecting rigid components to be extending beyond the door edge.

Accordingly, there is a need for a device to cover and protect locking devices, such as padlocks, that is inexpensive, easy to install on or retrofit to access doors where the locking device is used. Such a device should have a limited number of components that may be rigidly attached to the access doors and access areas to be secured, with such components being easily manufactured from robust and secure materials. Such a device does not currently exist, but is eagerly sought to improve the security of access doors, access areas, and locking devices.

### SUMMARY OF THE INVENTION

In view of the shortcomings of the prior art, it is an object of the present invention to provide a security apparatus to cover and protect a locking device, such as a pad lock, where the locking device is used to secure an access door. It is a further object of the present invention that the security apparatus can be easily installed onto access doors currently in place using a limited number of readily available and easily fabricated elements.

To achieve this and other objects, and in view of its purposes, the present invention provides a protective cover for use with a locking device, the protective cover comprising a protective shroud sized to cover at least part of the locking device; means to affix the protective shroud in place over the locking device; and a hasp element to which the locking device engages under the protective cover, such that upon locking the locking device to the hasp element, the locking device can not be removed from the hasp element unless the locking device is unlocked.

In another embodiment of the present invention, a protective cover for use with a locking device is provided, the protective cover comprising a protective shroud sized to cover at least part of the locking device; a plurality of anchors attached to the protective shroud; means to affix the protective shroud in place over the locking device; and a hasp element to which the locking device engages under the protective cover, such that upon locking the locking device to the hasp element, the locking device can not be removed from the hasp element unless the locking device is unlocked.

In yet another preferred embodiment of the present invention, there is provided a protective cover system to shield locking devices, the locking devices used to secure access doors and access areas, the protective cover system comprising a protective shroud attached to an access door, said access door preventing entry to an access area; an aperture formed in the access door under the protective shroud; a hasp element attached to the interior of the access area, the hasp element extending through the access door aperture; and a locking device lockable to the hasp element such that upon closing the access door and locking the locking device to the hasp element under the protective shroud, the locking device is at least partially covered by the protective shroud, the locking device can not be removed from the hasp element, and the access door can not be opened unless the locking device is unlocked.

In still another preferred embodiment of the present invention, a method of securing an access door and access area and shielding a locking device is provided, the locking device being used to secure said access door and access area, the method comprising the steps of affixing a protective shroud attached to the access door; forming an aperture in the access door in a location under the protective shroud; affixing a hasp element within the access area behind the access door, whereby said hasp element extends through the access door aperture; and after closing the access door, lockably engaging a locking device to the hasp element under the protective shroud, whereby the locking device is at least partially covered by the protective shroud, and the locking device can not be removed from the hasp element, and the access door can not be opened unless the locking device is unlocked.

These and other aspects of the present invention are set forth below with reference to the drawings and the detailed description of certain preferred embodiments. It is to be understood that both the foregoing general description and the following detailed description are exemplary, and are not intended to be or should be considered restrictive of the invention.

### BRIEF DESCRIPTION OF THE DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawings are the following Figures:

FIG. 1 is a perspective view of an illustration of the present inventive locking device protective cover without anchors;

FIG. 2 is a perspective view of an illustration of the present inventive locking device protective cover with four rigidly attached anchors;

FIG. 3 is a perspective view of an illustration of the present inventive locking device protective cover installed on an access door over an underground access area with the access door partially open;

FIG. 4 is a side view of an illustration of the present inventive locking device protective cover installed on an access door over an underground access area with the access door closed;

FIG. 5A is an overhead cut-away view of an illustration of the present inventive locking device protective cover installed on an access door over an underground access area with the padlock engaged and locked and the protective cover shielding the entire locking device;

FIG. 5B is an overhead cut-away view of an illustration of the present inventive locking device protective cover installed on an access door over an underground access area with the padlock engaged and locked and the protective cover shielding a portion of the locking device; and

FIG. 6 is a perspective view of an illustration of the present inventive locking device protective cover installed on an access door to a security cabinet with the security cabinet access door partially open.

### DETAILED DESCRIPTION OF PREFERRED EMBODIMENTS

The present invention is directed to a cover or shroud designed to protect a locking device such as a padlock. The protective cover is designed using a limited number of relatively standard elements. The inventive shroud apparatus is also designed to be easily installed to, or retrofitted to, and used with access doors and access areas in order to add a further level of security to the access areas. Such access doors include by example, and without limitation, (a) access doors over underground access ways maintaining water mains, gas mains or electrical infrastructure; (b) access doors to water towers; (c) access doors to utility cabinets; and (d) access doors to other infrastructure facilities.

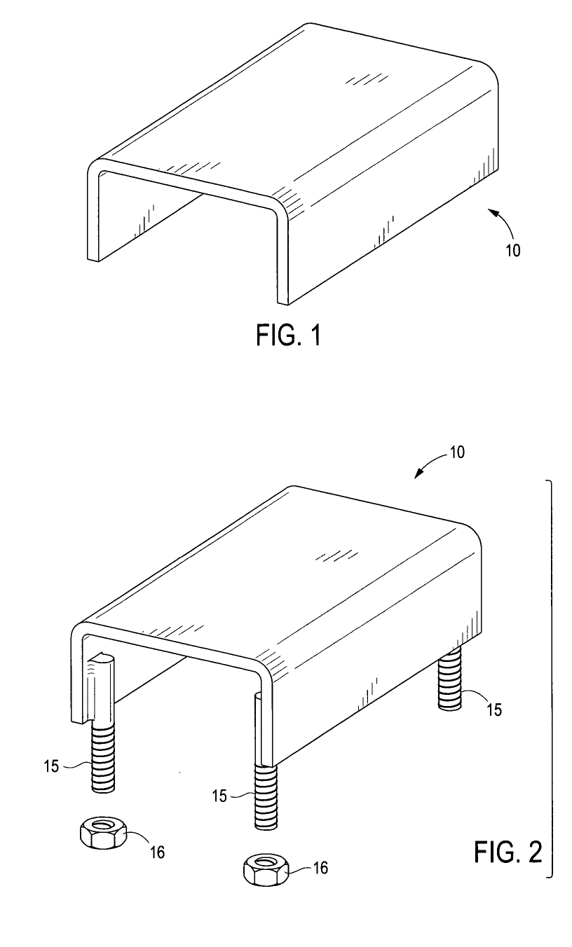

In a preferred basic embodiment of the inventive shroud apparatus, the apparatus has three primary components to allow use with a locking device and to secure unauthorized opening of an access door. The components include a protective cover or shroud, as shown in FIG. 1, means to rigidly affix the protective shroud to the access door, and a hasp element located under the protective cover and to which a locking device locks.

In another preferred embodiment, as shown in FIG. 2, the inventive shroud apparatus has four primary components including the three above noted components, and further including a plurality of anchors rigidly attached to the protective shroud, such that the anchors are used to attach the protective cover to the access door.

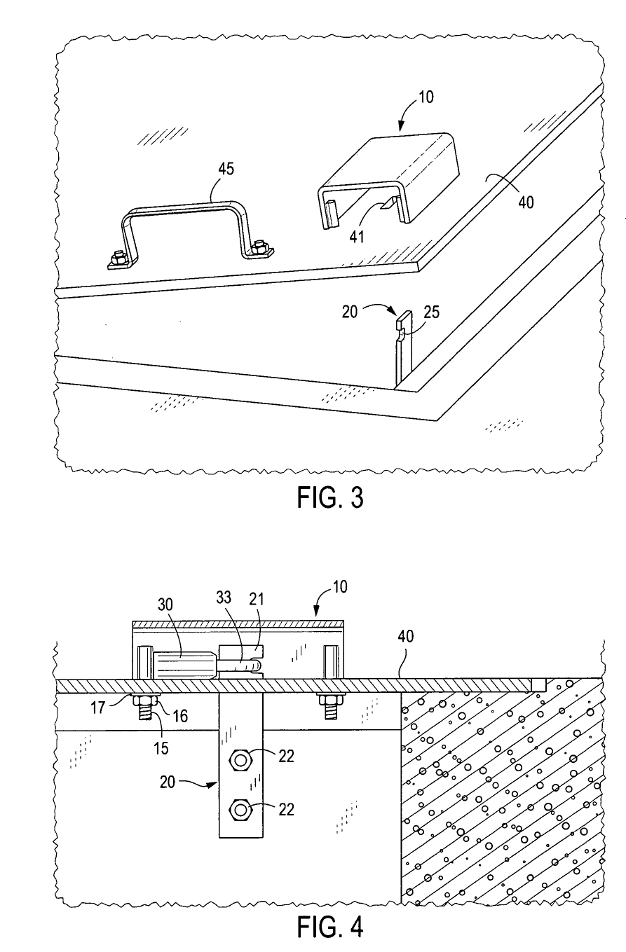

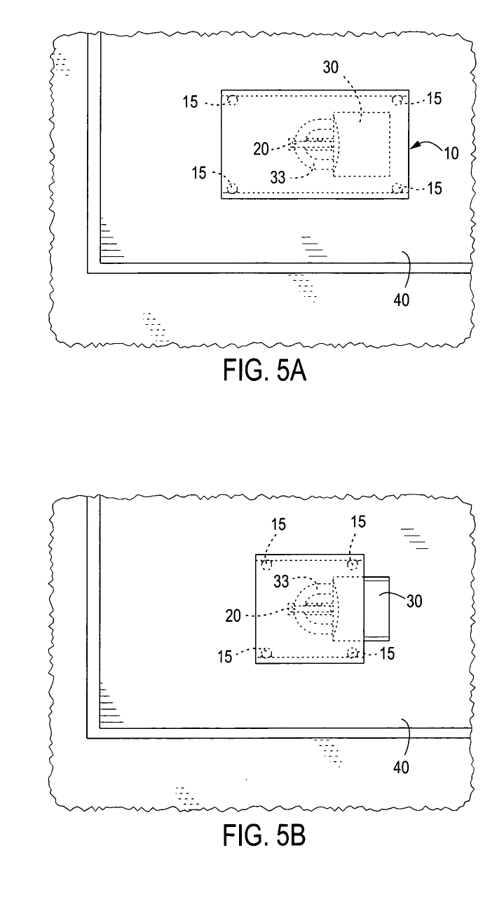

As illustrated in FIG. 3, in one preferred embodiment, the protective lock shroud has a cover 10 that is attached to an access door 40. The cover is sized such that the cover shields at least part of the locking device 30. For the embodiment shown in FIGS. 4 and 5A, the cover 10 is large enough so that it protects the entire locking device 30. In another preferred embodiment, shown in FIG. 5B, the cover may be shortened and shield only the top part of the locking device 30.

As shown in FIG. 3, the cover may be rigidly attached to the access door 40 by, for example, welding or an epoxy adhesive. In another preferred embodiment, the cover 10 alternatively may be attached to the access door 40 by use of a series of anchors 15. The anchors are rigidly affixed to the cover 10. With the use of anchors, the cover 10 and anchors may be welded to the access door, or affixed with an epoxy adhesive.

In another preferred embodiment of the inventive cover uses anchors 15 that are welded to the cover at one end of the anchor, and having standard bolt-type threads at the other end of the anchor 15, as shown in FIG. 2 and FIG. 4. With the threaded anchors, the cover 10 may be bolted to the access door 40 through use of standard washers 17 and nuts 16 that fit with the threaded sections of the anchors 15. Using four anchors located at or near the four corners of the cover 10, substantial strength is provided to the cover 10 attached to the access door 40.

To lock the access door 40, the locking device 30 is locked to a hasp element 20. As shown in FIGS. 3 and 4, the hasp element 20 is rigidly attached to the interior of the access area or access way. In one preferred embodiment, the hasp element is attached to the inside of the access area through a plurality of anchors 22. An example of such an installation would be to attach the hasp element to a concrete wall section, as shown in FIG. 4, by two or more bolts. The bolts may be screwed into the concrete wall section, or in another preferred embodiment, may be epoxied into holes drilled into the concrete. Alternatively, the hasp element 20 may be welded to the interior of the access area assuming a metallic section is available to which the hasp element may be affixed by welding.

As shown in FIG. 4, the hasp element 20 has a length such that when the access door 40 is in a closed position, an end section 21 of the hasp element 20 extends through the access door 40 positioned under the cover 10. In order for the hasp element 20 to extend through the access door 40, an aperture 41 is cut in the access door 40. The shape and size of the aperture 41 should, in a preferred embodiment, permit the hasp element 20 to extend through the access door 40, but should not be so large or wide so as to provide excess space between the hasp element 20 and the access door. In other words, the aperture 41 should be sized and shape to provide close spacing between the hasp element 20 and access door 40 when the access door 40 is being opened and closed, and when the access door 40 is completely closed.

The hasp end section 21 that extends through the access door 40 has a notch 25 or cut-out that is sized to allow for locking engagement of the locking device 30 with the hasp element 20. As shown in one preferred embodiment with a padlock type of locking device 30, in FIG. 5A, the padlock shackle 33 engages or fits within the hasp end section notch 25. With the access door 40 closed, the hasp element end section 21 extending through the access door aperture 41 positioned under the cover 10, a locking device 30 may thus be locked to the hasp element 20. In this locked configuration, the locking device 30 can not be removed from the hasp element 20, and the access door 40 can not be opened until the locking device 30 is unlocked and the locking device is removed from the hasp element 20.

In the closed and locked configuration, the locking device is shielded and protected from various types of tampering and vandalism. For example, as noted above, the cover 10 protects the locking device from being damaged or destroyed by bolt cutters. That is, as shown in FIG. 4, because the cover 10 shields the locking device 30 or padlock shackle 33, bolt cutters can not reach or cut the locking device 30. The cover 10 also provides an added level protection from damage due to unintentional or inadvertent contact or collisions with workers or equipment.

To provide a substantial material for the locking device cover, in one preferred embodiment, the cover 10 and hasp element 20 may be made of approximately 1/4 inch stainless steel. Stainless steel is a preferred material for the cover 10 and hasp element 20 because many access doors 40 and access areas are located outside which subjects the cover, hasp element and locking device to the elements, including rain, snow and dirt. Moreover, stainless steel is a readily available material. Other materials, in other embodiments may also be used, such as a composite material or Kevlar®. While such a composite will provide a level of protection from the environment, it will not provide the same type of security that a solid stainless cover offers.

For the preferred embodiment illustrated in FIGS. 3 and 4, the inventive cover may be easily and quickly retrofitted to access doors that are already in place. The method of securing an access door and providing protection to a locking device includes the first step of drilling holes in the access door 40 for each of the threaded anchors 15. The cover 10 may then be quickly installed on-site by bolting the cover to the access door 40. Similarly, the hasp element 20 may be easily installed inside the access area by rigidly affixing the hasp element 20 to a solid section by, for example, bolts or welding. Finally, to allow the hasp element end section 21 to extend through the access door 40 in position under the cover 10, an aperture 41 may be cut in the access door 40 under the cover aligned with the hasp element end section 21.

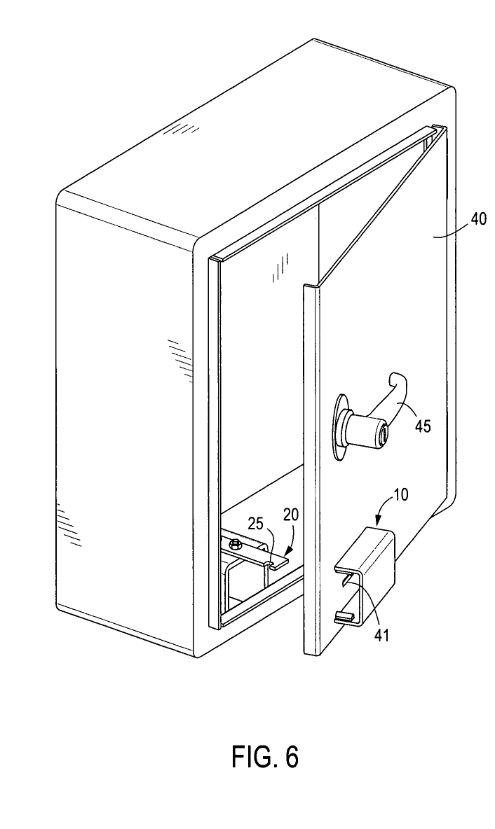

Although the illustrations of the cover 10 shown in FIGS. 1 through 6 show the cover having a channel or U shape, the cover may have alternate shapes, sizes or configurations. For example, the cover 10 may be shaped as a concave dome that is easily formed by bending stainless steel over a cylinder form. Alternatively, in another preferred embodiment, the cover 10 may be custom shaped to the locking device configuration. This would prevent substantial movement of the locking device once it is engaged with and locked to the hasp element 20. While the custom shaping of the cover 10 provides further protection to the locking device, it also entails additional manufacturing time and cost.

The inventive protective cover pieces or elements, including stainless steel for the cover and hasp, bolts and nuts, and standard locking devices are all readily available and easily stocked. As such, intricate or complex fabrication or retrofitting of access doors or access ways is not necessary. Accordingly, a simple but highly secure cover system for use with locking devices has been disclosed.

Although the invention has been described with reference to exemplary embodiments, it is not limited thereto. For example, while disclosure and illustration of the inventive locking device protective cover has been primarily made through the illustration of a channel shaped cover, the cover 10 may be sized and shaped differently, and have similar utility and effectiveness, so long as the cover 10 shields at least part of the locking device 30. Similarly, the cover 10 may be affixed to an access door that is in place over an underground access way, or affixed to a security cabinet door. Accordingly, it is intended to be and should be understood that the following claims are to be construed to include other variants and embodiments of the invention which may be made by those skilled in the art as being within the true spirit and scope of the present invention.

1. A protective cover for use with a locking device, said protective cover comprising:
a protective shroud sized to cover at least part of the locking device;
means to affix the protective shroud in place over the locking device; and
a hasp element to which the locking device engages under the protective cover, such that upon locking the locking device to the hasp element, the locking device can not be removed from the hasp element unless the locking device is unlocked.

2. A protective cover for use with a locking device, said protective cover comprising:
a protective shroud sized to cover at least part of the locking device;
a plurality of anchors attached to the protective shroud;
means to affix the protective shroud in place over the locking device; and
a hasp element to which the locking device engages under the protective cover, such that upon locking the locking device to the hasp element, the locking device can not be removed from the hasp element unless the locking device is unlocked.

3. The locking device protective cover, according to claim 1, wherein the protective shroud is made from stainless steel.

4. The locking device protective cover, according to claim 1, wherein the protective shroud is made from approximately quarter inch thick stainless steel.

5. The locking device protective cover, according to claim 1, wherein the plurality of anchors are each threaded bolts welded to the protective cover, and the affixing means are a plurality of nuts respectively threaded to engage the threaded bolts to mount the protective cover in place.

6. The locking device protective cover, according to claim 1, wherein the affixing means is an epoxy adhesive use to affix the plurality of anchors and protective cover in place.

7. The locking device protective cover, according to claim 1, wherein the locking device is a padlock having a pivoting shackle.

8. The locking device protective cover, according to claim 7, wherein the protective shroud covers at least the padlock pivoting shackle.

9. A protective cover system to shield locking devices, said locking devices used to secure access doors and access areas, said protective cover system comprising:
a protective shroud attached to an access door, said access door preventing entry to an access area;
an aperture formed in the access door under the protective shroud;
a hasp element attached to the interior of the access area, said hasp element extending through the access door aperture; and
a locking device lockable to the hasp element such that upon closing the access door and locking the locking device to the hasp element under the protective shroud, the locking device is at least partially covered by the protective shroud, the locking device can not be removed from the hasp element, and the access door can not be opened unless the locking device is unlocked.

10. The protective cover system, according to claim 9, wherein the protective shroud is made from ¼ inch stainless steel.

11. The protective cover system, according to claim 9, wherein the hasp element is made from ¼ inch stainless steel.

12. The protective cover system, according to claim 9, wherein the locking device is a padlock having a pivoting shackle.

13. The protective cover system, according to claim 12, wherein the hasp element has a notch into which the padlock shackle fits.

14. The protective cover system, according to claim 12, wherein the protective shroud covers at least the padlock shackle.

15. The protective cover system, according to claim 12, wherein the protective shroud covers the entire padlock.

16. A method of securing an access door and access area and shielding a locking device, said locking device being used to secure said access door and access area, said method comprising the steps of:
affixing a protective shroud attached to the access door;
forming an aperture in the access door in a location under the protective shroud;
affixing a hasp element within the access area behind the access door, whereby said hasp element extends through the access door aperture; and
after closing the access door, lockably engaging a locking device to the hasp element under the protective shroud, whereby the locking device is at least partially covered by the protective shroud, and the locking device can not be removed from the hasp element, and the access door can not be opened unless the locking device is unlocked.
